(19) United States
(12) Patent Application Publication
(10) Pub. No.: US 2025/0334531 A1
(43) Pub. Date: Oct. 30, 2025

(54) METHOD AND MEASURING DEVICE FOR MEASURING A TEST OBJECT BY MEANS OF X-RAY FLUORESCENCE

(71) Applicant: Helmut Fischer GmbH Institut fuer Elektronik und Messtechnik, Sindelfingen (DE)

(72) Inventor: Martin Leibfritz, Deckenpfronn (DE)

(21) Appl. No.: 18/865,256

(22) PCT Filed: Jul. 20, 2023
(86) PCT No.: PCT/EP2023/070100

§ 371 Date: Nov. 12, 2024

(30) Foreign Application Priority Data
Jul. 26, 2022 (DE) 10 2022 118 717.9

(51) Int. Cl. G01N 23/223; G01B 15/02; G06T 7/571

(52) U.S. Cl. CPC G01N 23/223; G01B 15/02; G06T 7/571; G01N 2223/401; G01N 2223/408; G06T 2207/10148

(57) ABSTRACT

Method for measuring a test object using a measuring device by means of X-ray fluorescence, in which a structure of the measuring point of the test object is detected before a measuring task is carried out and the image capture device is moved in the direction of the measuring table and an image of the measuring point of the test object is acquired from each step of the displaced focal plane and all images are converted into a summed image and is output in a display.

The invention relates to a method for measuring a test object with a measuring device by means of X-ray fluorescence, and to such a measuring device, which is provided in particular for measuring the thickness of thin layers on the test object or for determining an element concentration of the test object.

In many areas of industrial production, increasingly small structures are being used, such as so-called bond pads on printed circuit boards. Individual areas of these structures are located in different planes that need to be inspected depending on the measurement task. In measuring devices for carrying out a measurement using X-ray fluorescence, optical devices are provided whose beam path is coupled via a coupling element into a primary radiation of a radiation source directed onto the object to be measured by an X-ray fluorescence device. This enables an image to be captured of a measuring point on the object to be measured. These optical devices have a limited depth of field, which is physically determined. This makes it difficult for the user to adjust the measuring device to the measuring plane of the structure of the object to be measured for X-ray fluorescence measurement, which is the basis of the measuring task. Setting the measuring device for X-ray fluorescence measurement to the correct measuring plane in the structure of the object to be measured is relevant in order to achieve an increased intensity of the emitted secondary radiation for improved evaluation. This increased intensity can only be achieved if a focal plane of the primary beam lies in the measurement plane of the small structure of the test object to be tested. On the other hand, the adjustment of the test object to the correct measurement plane is relevant in order not to illuminate structures on the test object that are not of interest and enlarge the measurement spot.

Furthermore, measuring devices are known which provide X-ray optics, in particular so-called polycapillaries, between the radiation source of the X-ray fluorescence device and the object to be measured, by means of which the intensity can be increased in a small measuring spot. However, this measuring spot is larger than the measuring point of such small structures of the object to be measured, so that neighboring areas of the measuring point are also excited by the primary radiation within the measuring spot. The smaller the measuring spot, the closer the focal plane is to the exit of the polycapillary. The problem here is that it is difficult or impossible to couple the beam path to capture an image of the measuring point.

The invention is based on the object of proposing a method for measuring a test object with a measuring device by means of X-ray fluorescence, as well as a measuring device by means of which a structure with differing measurement planes is detected in the measurement point of the test object, thereby enabling the primary beam to be aligned with a specific measurement plane.

This object is solved by a method for measuring a test object with a measuring device by means of X-ray fluorescence, in which a primary beam of a radiation source is directed by an X-ray fluorescence device onto the test object positioned on a measuring table of the measuring device and in which a secondary beam emitted by the test object is detected by a detector of the X-ray fluorescence device and forwarded to an evaluation device and evaluated. An optical device, which comprises an image capture device and a focusing optical unit, couples a beam path of the image capture device into the primary beam via a coupling element and directs it onto a measuring point of the object to be measured and captures an image of the measuring point. Before a measurement task is carried out for one or more test objects, a structure of the measurement point of the test object is captured. Starting from a distance Dₛ above the measuring table, a focus plane is moved towards the measuring point of the test object by a controllable focusing optical unit until a highest point of the measuring point of the test object is detected by an image and a distance D₁ to it is determined. Starting from this distance D₁, the focusing optical unit is controlled in several steps so that the focal plane of the beam path of the image capture device is moved towards the surface of the measuring table and an image and the associated distance D₂, D₃ . . . Dₙ is captured and that a summed image of all captured images is determined by the evaluation device and are output on a display connected to the measuring device. The advantage of this method is that the different measuring planes in the small structures of the measuring point of the measuring object can be shown in sharp focus on the display. This enables the user to precisely approach and set the corresponding measuring plane on the small structure of the measuring point for the subsequent measuring task.

It is preferable that all captured images of the measurement point of the test object are converted into the summed image by an algorithm, in which the measurement point is output with a depth of field over the entire height of the structure of the measurement point by a display. Such an algorithm can be provided in such a way that an image transformation is carried out for the individual images for the subsequent best possible superimposition. Such algorithms are used in special software, for example to perform focus-stacking or focus-variation. For optics with a limited depth of field, this makes it possible to obtain an image at the measuring point of the test object with a full depth of field over the entire height of the structure and three-dimensional information about the structure of the measuring point.

Furthermore, it is preferable that the distance Ds above the measuring table or the measuring object, from which the movement of the focal plane of the focusing optical unit from the beam path of the image capture device towards the measuring point of the measuring object takes place, is determined in the evaluation device or is determined by a calibration of the measuring device. As a result, a recurring starting point for determining the structures can be selected for this detection of the small structures for a subsequent measurement of a measuring point in a predetermined measuring plane of the test object.

It is advantageous that the highest point of the measuring point of the object to be measured is detected by an autofocus measurement to determine a first distance D₁ or a minimum distance of the object to be measured. This allows the highest point of the measuring point to be determined automatically.

An electrically controllable focusing optical unit is preferably provided to change the focal plane of the beam path of the image capture device. The preferably step-by-step displacement of the focal plane of the beam path or image capture device for detecting the small structures at the measuring point on the test object is preferably carried out by changing the voltage values for controlling the focusing optical unit, whereby each change in the voltage value results in a displacement of the focal plane and each voltage value is assigned a distance D₁ to Dₙ for determining the position of the focal plane. In each focal plane, an image is preferably captured by the image capture device, which in turn is used to form the summed image. At the same time, the individual voltage values for the determined distances are stored in the evaluation device so that the values for a specific focal plane on the small structure can be taken into account for adjusting the measuring spot of the primary beam on the structure of the test object.

Advantageously, a maximum distance Dₘₐₓ, which lies on the surface of the measuring table, is also recorded in the evaluation device. This allows the range of movement of the focal plane between the distance Dₛ and Dₘₐₓ to be stored, so that a plausibility check can be carried out at the same time if a distance is detected that is outside this travel range.

It is preferable that the distance Dₛ, D₁ . . . Dₙ, Dₘₐₓ is determined starting from a coupling plane of the beam path of the image capture device into the primary beam in the direction of the surface of the measuring table.

For example, an electrically controllable liquid lens can be used as the electrically controllable focusing optical unit for carrying out the process. Alternatively, the focusing optical unit can also be controlled by a geometric movement of lenses and/or an image plane of the image capture device.

Furthermore, it is preferable that the optical device is calibrated before the structures of the test object are detected by placing a calibration standard with a known structure on the measuring table, which comprises several planes of focus and the distance of the plane of focus of the calibration standard is recorded by changing the voltage values for each voltage value and, if the distance deviates from the known plane of focus of the calibration standard, a correction of the voltage value is carried out for a certain voltage value to the closest recorded plane of focus of the calibration standard. This calibration step allows the measuring device, in particular the optical device, to be optically calibrated before the subsequent measurement task. As a result, an increased measurement quality can be achieved.

The object underlying the invention is further solved by a measuring device for test objects with X-ray fluorescence, which comprises a housing with a measuring table on the surface of which a measuring object can be positioned and with an X-ray fluorescence device which comprises a radiation source for emitting a primary beam and a detector for detecting an emitted secondary radiation from the measuring object and with an optical device which comprises an image capture device and a focusing optical unit, an evaluation device being provided for carrying out the method according to one of the embodiments described above.

The invention and other advantageous embodiments and further embodiments thereof are described and explained in more detail below with reference to the examples shown in the drawings. The features to be taken from the description and the drawings can be used individually or in any combination in accordance with the invention. It shows:

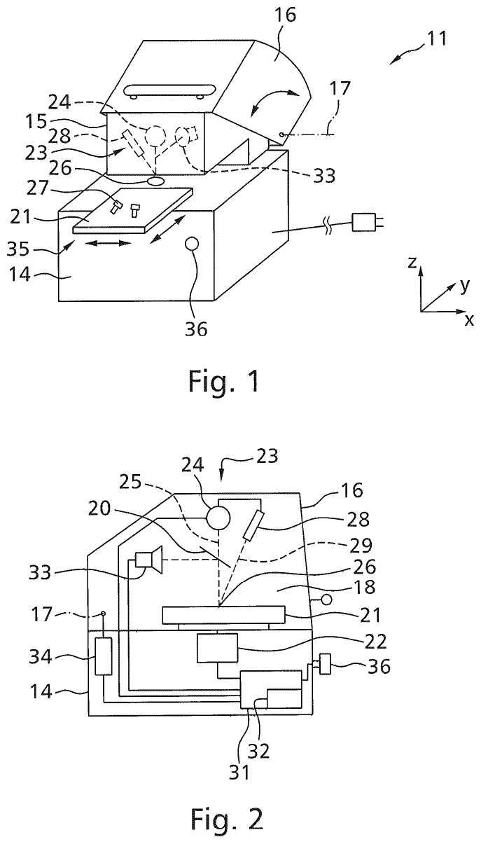

FIG. 1 a perspective view of a measuring device,

FIG. 2 a schematic sectional view of the measuring device according to FIG. 1, and

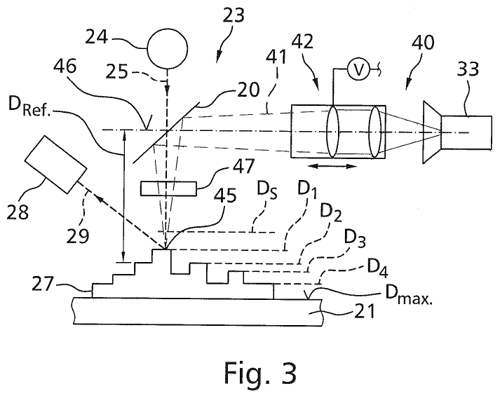

FIG. 3 a schematic side view of the optical device with a focusing optical unit for detecting structures at the measuring point of the object to be measured.

FIG. 1 shows a measuring device 11 in perspective. FIG. 2 shows a schematic side view of the measuring device according to FIG. 1 in a sectional view. This measuring device 11 is used to carry out a measurement on test objects using X-ray fluorescence. The measurement using X-ray fluorescence can be used to measure the thickness of coatings on test objects and/or to analyze the material of the test object.

The measuring device 11 comprises a housing 12 with a lower housing section 14 and an upper housing section 15 as well as a housing cover 16. The housing cover 16 is, for example, mounted so that it can pivot about a pivot axis 17, so that a measuring chamber 18 provided in the housing 12 is accessible. Alternatively, the housing cover 16 can also be moved or displaced relative to the housing 12 by a further mechanism. Instead of a pivoting housing cover 16, a housing opening can also be provided which allows access to the measuring chamber 18.

The lower part of the housing 14 accommodates a movable measuring table 21 on an upper side. This measuring table 21 is driven in the X and Y directions by a motor 22. Preferably, the measuring table 21 is guided by a cross table or the like so that it can be moved relative to the lower housing part 14.

An X-ray fluorescence device 23 is provided in the upper part of the housing 15. This comprises a radiation source 24, through which a primary beam 25 is directed onto a measuring point 26. Individual components arranged in the primary beam 25, such as a shutter, a primary filter and/or a collimator, are not shown in detail. Individual test objects 27, which rest on the measuring table 21, for example, can be positioned in alignment with the measuring point 26 in order to carry out a measurement. A detector 28 is provided adjacent to the radiation source 24, which detects secondary radiation 29 emitted by the test object 27.

Both the radiation source 24 and the detector 28 are connected to a control unit 31.

The control device 31 comprises an evaluation device 32 so that measuring tasks can be stored and called up and/or that determined measured values can be recorded, stored and/or evaluated and/or output in a display or the like.

An optical device 40 is provided in the upper part of the housing 15, which comprises an image capture device 33, such as a CCD camera, and a focusing optical unit 42, by means of which an image or an overview image of at least one area of the measuring table 21 or preferably of the entire measuring table 21 can be captured. The optical device 33 can capture images of the measuring point 26 and/or of the measuring table 21 via a deflecting mirror 20. The housing cover 16 can be opened and closed automatically via a motor 34, which in turn is connected to the control device 31. This provides easy access to the measuring chamber 18. A button element 36 is preferably provided on the lower part of the housing 14, by means of which the control device 31 can be started or stopped and/or activated.

Advantageously, a display, screen or the like can be connected to the measuring device 11. A display, a display or a screen can also be provided on the housing 12.

To make it easier to load the measuring table 21 with the at least one test object 27 for the subsequent measuring task, the measuring table 21 can be moved into a loading and unloading position 35. In this loading and unloading position 35, the measuring table 21 is at least partially extended relative to the lower part of the housing 14. The housing cover 16, which can be lifted off the lower housing part 14, can provide improved accessibility to the measuring table 21, which is arranged in the loading and unloading position 35. This loading and unloading position 35 of the measuring table is shown in FIG. 1.

To carry out the measurement task at hand, the measuring table 21 is moved from the loading and unloading position 35 to a working position 37. This working position 37 is shown in FIG. 2. The measuring table 21 is positioned completely within the measuring chamber 18. After closing the housing cover 16, the measuring table 21 is positioned completely within the closed measuring chamber 18.

Alternatively, it can be provided that the loading and unloading position 35 and the working position 37 are the same position. In this case, the housing cover 16 is preferably liftable or laterally displaceable relative to the lower housing part 14, so that good accessibility is again provided for loading and unloading the measuring table 21 with the at least one measuring object 27.

Alternatively, it is also possible for the measuring table 21 of the measuring device 11 to be fixed. In this case, the measuring objects 27 can be placed on the measuring table 21 individually or in groups. The X-ray fluorescence device 23 and/or the optical device 33 can then be moved accordingly to the measuring point 45 of the test object 27.

FIG. 3 shows a schematic side view of the X-ray fluorescence device 23 and the optical device 33 with the image capture device 33 and the focusing optical unit 42. The measuring object 27 is placed on the measuring table 21. This measuring object 27 comprises a measuring point 45 which comprises, for example, a structure which has measuring planes at different heights. The structure of the measuring point 45 is shown substantially enlarged. These structures can be smaller than 500 μm, in particular smaller than an optical wavelength of 600 nm. In other words, such structures are preferably smaller than a microfocus of an optical system in which a measuring spot of greater than 500 μm can be set. The illustration of the structure is only an embodiment example and this structure may have any shape and need not comprise the staircase or pillar structure shown.

An optical beam path 41 of the image capture device 33 is coupled into the primary beam 25 via a coupling element 20 or a deflecting mirror. Starting from a beam axis of the image capture device 33 or coupling plane 46, a distance to the surface of the measuring table 21 and/or to the structure of the measuring point 45 of the measuring object 27 is detected. A collimator 47 can preferably be provided between the coupling element 20 and the measuring table 21. This is used in particular to adjust the size of the measuring spot of the primary beam 25 in a measuring plane on the measuring point 45 of the test object 27.

One measurement task for measuring the measuring point 45 on the test object 27 can be to determine the thickness of a coating on the test object 27. The measuring task can also be to determine a material analysis or an element concentration of individual measuring planes within the structure. This can be done in order to check whether the coating is sufficiently thick within the individual structures or whether the required element concentrations are present

To record the structure of the measuring point 45 on the test object 27, proceed as follows:

The electrically controllable focusing optical unit 42 is set so that the focal plane of the beam path 41 lies in the plane according to the distance Dₛ. This distance Dₛ can be a fixed, calibrated or programmed distance in the evaluation unit 32. The distance Dₛ is preferably determined starting from the coupling plane 46. It can also be determined starting from the surface of the measuring table 21. Starting from this starting point, the focal plane of the beam path 41 is moved in the direction of the measuring table 42. The highest point of the measuring point 45 of the measuring object 27 is detected by an autofocus measurement. This is also the smallest distance between the structure of the test object 27 and the coupling plane 46. This highest point of the structure of the measuring point 45 of the test object 27 can be recorded and stored as Dₘᵢₙ or as D₁. Due to the electrically controllable focusing optical unit 42, a specific voltage value is present at the focal plane at distance D₁. This is assigned to the distance D₁. At this focal plane at distance D₁, an image is captured by the optical device 40 and stored. Subsequently, a change in the focal plane is preferably triggered step by step by a correlating change in the voltage value for controlling the focusing optical units 42. For example, the focal planes are then approached at distances D₁, D₂ . . . Dₙ. The respective voltage value is recorded from each distance D₁ . . . Dₙ and an image is created by the image capture device 33. This traversing movement is ended at the latest when the focal plane is at a distance Dₘₐₓ. The distance Dₘₐₓ corresponds to the distance between the coupling plane 46 and the surface of the measuring table 21.

The individual captured images are then processed by means of an image transformation, preferably a Fourier transformation, so that they can then be superimposed. A so-called focus-stacking or focus-variation can be used to output and display a sharp overview image of the structure of the measuring point 45 in a display of the measuring device 11.

This procedure allows the user of the measuring device 11 to see the complete structure of the measuring point 45 of the test object 47 clearly, even in depth, and thus to select and define the desired measuring point or measuring plane for the primary beam 25 for the measurement to be carried out. This has the advantage that a maximum intensity can be introduced into the measuring plane, which is to be detected by the measuring task, in order to achieve sufficient secondary radiation for the subsequent evaluation of the measuring point 45.

This method for detecting the structure of the measurement point 45 on the test object 27 also has the advantage that, for example, pattern recognition of a test object 27 is also possible, since the detection of dedicated target patterns from a three-dimensional overall image that is sharp in depth is easier to determine.

Before the structure of the measuring point 45 on the test object 27 is recorded, the test object 11 can be calibrated in a first step. Preferably, a calibration standard with a known structure comprising several measuring planes is placed on the measuring table 21. This known structure, also referred to as a focus standard, comprises several different focus planes (measuring planes), whereby the distance from at least one focus plane to a support plane of the calibration standard on the measuring table 21 is known. The electrically controllable focusing optical unit 42 then move the beam path 41 with respect to the focal plane within the calibration standard 42 and record the respective associated voltage values. If the voltage value deviates from the known focal plane of the calibration standard 42 to the closest focal plane of the calibration standard 42, the voltage value is corrected. The voltage value correlates with a defined distance between the focal plane of the beam path 41 and the coupling plane 46 or surface of the measuring table 21, so that any tolerances or errors can be corrected.

1. Method for measuring a test object with a measuring device by means of X-ray fluorescence for measuring the thickness of thin layers on the test object or for determining an element concentration in the test object,
in which a primary beam of a radiation source is directed from an X-ray fluorescence device onto the test object which is positioned on a measurement table,
in which a secondary radiation emitted by the test object is detected by a detector of the X-ray fluorescence device and forwarded to an evaluation device,
in which an optical device, which comprises an image capture device and a focusing optical unit, is used to couple a beam path of the optical device via a coupling element into the primary beam and direct it onto a measuring point of the test object to be measured, and an image is acquired from the measuring point,
wherein
a structure of the measuring point of the test object is detected before a measuring task is carried out for the test object positioned in the measuring device,
a focal plane of the beam path of the image capture device is approached by a controllable focusing optical unit at a distance Dₛ, the distance Dₛ corresponding to a position of the focal plane above the measuring table and above the object to be measured,
the focal plane is then moved by the focusing optical unit towards the measuring point of the test object,
a highest point of the measuring point of the test object is detected by an image of the image capture device and a distance D₁ to the measuring table is assigned,
starting from the distance D₁, the focusing optical unit is controlled in a plurality of steps and the focal plane of the beam path of the image capture device is moved by the focusing optical unit in the direction of the measuring table and an image of the measuring point of the test object is captured from each step of the displaced focal plane and a distance D₂ . . . Dₙ is assigned,
all the images captured by the image capture device are converted by the evaluation device into a summed image and are output in a display connected to the measuring device.

2. Method according to claim 1, wherein all captured images of the measuring point of the test object are converted into a summed image by an algorithm and the measuring point of the test object is output with a depth of field over the entire height of the structure of the measuring point by the display.

3. Method according to claim 1, wherein the distance Dₛ above the measuring table, above the test object, from which the traversing movement of the focus plane of the beam path towards the measuring point of the test object takes place, is set in the evaluation device or is determined by calibration of the measuring device.

4. Method according to claim 1, wherein the detection of the highest point of the measuring point of the test object for determining the distance D₁ is controlled and detected by an autofocus measurement.

5. Method according to claim 1, wherein an electrically controllable focusing optical unit is used and each step for displacing the focal plane of the beam path is controlled by a stepwise change in the voltage values of the focusing optical unit and in that each voltage value is assigned a distance D₁ . . . Dₙ for determining the respective focal plane in the connection with the structure of the test object.

6. Method according to claim 1, wherein a distance Dₘₐₓ, at which the focus plane of the beam path lies in the surface of the measuring table, is detected by a measurement with the optical device and stored in the evaluation device.

7. Method according to claim 1, wherein the distance Dₛ, D₁ . . . Dₙ is determined starting from a coupling plane of the beam path of the optical device into the primary beam in the direction of the surface of the measuring table.

8. Method according to claim 1, wherein at least one liquid lens or at least one geometrically movable optic is used as the electrically controllable focusing optical unit.

9. Method according to claim 1, wherein a calibration of the optical device is carried out before the structure of the measuring point of the test object is detected, in that a calibration standard with a known structure is placed on the measuring table, which comprises a plurality of planes of focus differing from one another and, by changing the voltage values for controlling the focusing optical unit, a distance of the plane of focus of the known structure of the calibration feature from the coupling plane is detected for each voltage value and, if the voltage value deviates from the known plane of focus of the calibration standard with respect to the determined voltage value of the same plane of focus, a correction of the voltage value is carried out.

10. Measuring device for measuring a test object by means of X-ray fluorescence for measuring the thickness of thin layers on the test object or for determining an element concentration,
with a housing,
with a measuring table provided in the housing, on the surface of which a test object is positionable,
with an X-ray fluorescence device which comprises a radiation source for emitting a primary beam and a detector for detecting secondary radiation emitted by the test object,
with an optical device, which comprises an image capture device and a focusing optical unit, and with a coupling element, through which a beam path of the image capture device is couplable into the primary beam,
wherein
an evaluation device is provided for carrying out the method according to claim 1.

11. Method according to claim 2, wherein the algorithm is of a focus-stacking or a focus-variation.
